(19) United States
(12) Patent Application Publication
(10) Pub. No.: US 2024/0030565 A1
(43) Pub. Date: Jan. 25, 2024

(54) CELL CONNECTION COMPONENTS AND BATTERIES

(71) Applicants: ZHEJIANG NARADA POWER SOURCE CO., LTD., Hangzhou (CN); HANGZHOU NARADA POWER TECHNOLOGY CO., LTD., Hangzhou (CN)

(72) Inventors: Feng GUO, Hangzhou (CN); Yinglai WANG, Hangzhou (CN); Jiayuan XIANG, Hangzhou (CN); Wen HUANG, Hangzhou (CN); Sishun LIU, Hangzhou (CN); Meng WANG, Hangzhou (CN); Liukou XU, Hangzhou (CN); Qinxu JIANG, Hangzhou (CN); Yanhong LI, Hangzhou (CN); Ling FANG, Hangzhou (CN); Bei ZHANG, Hangzhou (CN); Xiangdang CHEN, Hangzhou (CN); Shuting WEN, Hangzhou (CN); Huayan CAO, Hangzhou (CN)

(73) Assignees: ZHEJIANG NARADA POWER SOURCE CO., LTD., Hangzhou (CN); HANGZHOU NARADA POWER TECHNOLOGY CO., LTD., Hangzhou (CN)

(21) Appl. No.: 18/308,846

(22) Filed: Apr. 28, 2023

Related U.S. Application Data
(63) Continuation of application No. PCT/CN2022/107348, filed on Jul. 22, 2022.

(51) Int. Cl. H01M 50/536; H01M 50/172; H01M 50/147

(52) U.S. Cl. CPC H01M 50/536; H01M 50/172; H01M 50/147; H01M 10/0525

(57) ABSTRACT

A battery core connecting assembly and a battery are provided in this disclosure. The battery core connecting assembly is configured for connecting a core of a lithium-ion battery. The lithium-ion battery includes a top cover, and the battery core connecting assembly includes an adapting piece and a connecting piece which at least in part includes a single-layer structure. The adapting piece includes a first tongue and a second tongue which are connected with each other, the first tongue is configured to be welded with the core, the adapting piece is pliable at a pliable part of the first tongue and the second tongue, and the adapting piece has a multi-layer structure at least at the pliable part. The connecting piece is connected with the second tongue of the adapting piece, and the connecting piece is welded with the top cover at a position of the single-layer structure.

### CROSS-REFERENCE TO RELATED APPLICATION

This application is a continuation of International Application No. PCT/CN2022/107348, filed 22 Jul. 2022, the benefit of priority of which is claimed herein and which application is hereby incorporated by reference herein in its entirety.

### TECHNICAL FIELD

The disclosure relates to the technical field of batteries, in particular to a battery core connecting assembly and a battery.

### BACKGROUND ART

Lead-acid batteries are widely used in various fields because of their low price, easy access to raw materials and reliable performance. However, due to their low specific energy and short cycle life, the application fields of THE lead-acid batteries are limited.

Lithium-ion batteries have a high single-cell terminal voltage, high specific energy, long cycle life and environmental protection, which can just overcome shortcomings of the lead-acid batteries. Existing charging and discharging assemblies are classified into a wound type or a stacked type. A wound-type assembly is with a simpler process and is easier to operate, which is easy to realize industrial automation. At present, most enterprises in the market adopt the wound type. However, internal resistance of the wound-type assembly is high, and with a short battery life. This is because there is only one-way heat transfer between an electrode plate and a separator in a wound battery, which leads to serious temperature gradient distribution, high internal temperature and low external temperature, thus affecting the battery life. Furthermore, stressed area among a battery core, an electrode plate and a separator in a stacked battery is consistent, with no obvious stress concentration point, and the stacked battery is with high rate capability, capacity and density.

Whether it is a wound-type lithium-ion battery or a stacked lithium-ion battery, it always is a problem that puzzles skilled in this art to realize simple and reliable connection between an electrode plate and a top cover of the battery. Especially for stacked batteries, a tab of a stacked electrode plate makes connection more difficult. However, in existing technical schemes, the connection is made by butterfly welding cores on both side with a single connecting piece at one time, but a protruding length of the tab for this scheme is long; meanwhile, welding power is increased due to doubled welding levels at a single electrode, and probability of metal debris being generated and mixed into a battery core is increased; and ultrasonic welding with an excessive frequency affects service life of an ultrasonic welding head and reduces reliability of the ultrasonic welding.

In addition, because of complicated process steps of the stacked battery, it is difficult to achieve good consistency, which is also an important factor limiting wide application of the stacked battery.

### SUMMARY

In order to overcome at least one of deficiencies in related art, a battery core connecting assembly and a battery with reliable connection, convenient operation, low stress and long service life are provided in this disclosure.

In order to achieve above objects, a battery core connecting assembly for connecting a core of a lithium-ion battery is provided in this disclosure. The lithium-ion battery includes a top cover, and the battery core connecting assembly includes an adapting piece and a connecting piece which at least in part includes a single-layer structure. The adapting piece includes a first tongue and a second tongue which are connected with each other, the first tongue is configured to be welded with the core, the adapting piece is provided with a pliable part at a joint of the first tongue and the second tongue, and the adapting piece has a multi-layer structure at least at the pliable part. The connecting piece is connected with the second tongue of the adapting piece, and the connecting piece is welded with the top cover at a position of the single-layer structure.

In this disclosure, the adapting piece is skillfully combined with the connecting piece, so that a protruding size of the tab is reduced by 5% to 10% compared with a protruding size of the tab in the related art, and material loss of the tab can be reduced. Moreover, the tab is of a multilayer structure at the pliable part of the first tongue and the second tongue, which is easier to bend compared with the single-layer structure (for example, in a case of a same or close total thickness), is not subjected to function loss caused by breaking due to excessive stress concentration in special cases (vibration, impact, etc.), and is more effective in bending compared with some thinner single-layer structures. Moreover, the connecting piece is welded with the top cover at a position of the single-layer structure, and with easy welding such as laser welding of the single-layer structure of the connecting piece, the connection is reliable and material cost utilization of structural members is high.

In this disclosure, an expression” the connecting piece is welded with the top cover at a position of the single-layer structure” involves not only direct welding, such as direct welding with the top cover or the connecting piece being welded with a pole of the top cover when the top cover includes the pole; but also indirect welding, such as welding with the top cover or the pole of the top cover through another third component.

Moreover, the battery core connecting assembly in the disclosure is not only suitable for wound-type lithium-ion batteries, but also suitable for stacked lithium-ion batteries.

In this disclosure, a bending force of the adapting piece is less than 20N, and the pliable part can be repeatedly bent at 180 degrees for more than 30 times without breaking (while a bending force of a single layer with a same thickness is more than 50N, and bending times for the same thickness can only be less than 20), but the bending force and bending time are not limited in this disclosure.

Because a lithium-ion battery includes a positive electrode plate and a negative electrode plate, the connecting assembly in this disclosure can also be divided into a positive electrode plate connecting assembly and a negative electrode plate connecting assembly, and the positive electrode plate is configured for connecting with a positive electrode plate of a core, and correspondingly, the negative electrode plate is configured for connecting with a negative electrode plate of the core. A structure and shape of the positive and negative battery core connecting assemblies can be provided to be the same, and an adapting piece in the positive battery core connecting assembly is a positive adapting piece, and a connecting piece in the positive battery core connecting assembly is a positive connecting piece. Correspondingly, an adapting piece in the negative battery core connecting assembly is a negative adapting piece, and a connecting piece in the negative battery core connecting assembly is a negative connecting piece.

Optionally, the adapting piece can be made of soft materials and the connecting piece can be made of hard material.

The positive and negative battery core connecting assemblies can also be provided to be different. For example, the positive connecting piece can also be provided with a fusing and arc extinguishing apparatus, and a laser welding area of the negative connecting piece in a main body area of the connecting piece is a laser welding pockmark area, for preventing a problem of cold joints caused by high-intensity reflection of laser in laser welding.

Optionally, the first tongue and the second tongue are formed after the pliable part is bent, that is, on a section of the adapting piece (which can be a surface perpendicular to both the first tongue and the second tongue), the bend part is provided with a rounded corner, and the first tongue and the second tongue are transitioned with an arc at the pliable part, so as to facilitate bending. In an alternative embodiment, a central angle corresponding to the rounded corner is 90 degrees, or 180 degrees alternatively, When the central angle corresponding to the rounded corner is 90 degrees, the first tongue and the second tongue smoothly are transitioned with the rounded corner at the pliable part, which does not affect a height or length of the whole adapting piece. When the central angle corresponding to the rounded corner is 180 degrees, the rounded corner protrudes outward relative to the first tongue or the second tongue, which at this time slightly affects the height or length of the whole adapting piece. Of course, in other embodiments, the central angle corresponding to the rounded corner can be any other angle, such as an acute angle of 60 degrees and 45 degrees or an obtuse angle of 120 degrees and 150 degrees. The pliable part herein can be characterized by plastic deformation index (such as tensile strength, elongation, hardness, etc.), which is not limited in this disclosure.

Optionally, a thickness of a single layer of the adapting piece ranges from 0.05 mm to 0.2 mm, a number of layers of the adapting piece ranges from 2 to 8, and a total thickness of the adapting piece ranges from 0.3 mm to 1.8 mm.

Optionally, a number of layers of the positive electrode adapting piece can be more than that of the negative electrode adapting piece, and a total thickness of the positive electrode adapting piece can be larger than that of the negative electrode adapting piece. For example, a thickness of a single layer of the positive electrode adapting piece can range from 0.1 mm to 0.2 mm, a number of layers of the positive electrode adapting piece can range from 4 to 8, and a total thickness of the positive electrode adapting piece can range from 0.4 mm to 1.8 mm. A thickness of a single layer of the negative electrode adapting piece ranges from 0.05 mm to 0.2 mm, a number of layers of the negative electrode adapting piece ranges from 2 to 6, and a total thickness of the negative electrode adapting piece ranges from 0.3 mm to 1 mm.

Optionally, a diameter of the rounded corner ranges from 1.25 T to 2.5 T, where T is the overall thickness of the adapting piece. A too large or too small diameter range of the rounded corner has disadvantages. The too large diameter range may affect a height and size after bending, and The too small diameter range may lead to elastic stress concentration after bending. When the thickness of the adapting piece is small, an outer diameter or an inner diameter is not limited for the rounded corner in the disclosure, but when the thickness is large, the rounded corner can involve an inner diameter for convenience of measurement.

Optionally, a length of the first tongue of the adapting piece is longer than a length of the second tongue.

Optionally, the adapting piece and the connecting piece are independent of each other, and are two independent components. The whole connecting piece has a single-layer structure, and the whole adapting piece has a multi-layer structure. At this time, a molecular welding device is not necessary, which can reduce device cost. In other embodiments, the first tongue and the second tongue are separately provided to have a single-layer structure, and the pliable part has a multi-layer structure.

Optionally, the connecting piece includes a connecting piece body and connecting arms extending from the connecting piece body, the second tongue is welded with the connecting arms, and a number of the connecting arms corresponds to a number of the adapting pieces, which are, for example, even.

Optionally, the adapting piece is formed into an L-shape after the pliable part of the first tongue and the second tongue are bent, that is, an included angle of approximately 90 degrees is formed between the first tongue and the second tongue. There are two connecting arms and two adapting pieces, and the connecting arms are distributed on a same side or different sides of the connecting piece body. In a possible embodiment, the connecting arms are distributed on the same side of the connecting piece body, and the connecting piece is formed into a U-like structure. Some materials are required to be removed for the U-shaped structure which is with a long electron path, but with a large laser welding area (located in the connecting piece body). Using laser welding and because positions between the connecting piece body and the connecting arms for connecting with the second tongue are staggered, the whole connecting piece body can be reserved, and there is enough space for a positive U-shaped part to be fused, but with more ultrasonic weldings relatively. In another possible embodiment, the connecting arms located at the same side of the connecting piece may not be flush with an edge of the connecting piece body, forming a 7r-like shape.

In another possible embodiment, the connecting arms are distributed on different sides of the connecting piece body, and the connecting piece can be formed into a zigzag-like structure.

Optionally, two opposite sides of the connecting piece body can be provided with an inward concave groove, which can be engaged with a corresponding structural pin at a corresponding positions on the top cover, thus realizing positioning and fixing functions.

Optionally, the connecting piece may not be provided with additional connecting arms, and connecting pieces at this time may be in one-to-one correspondence to adapting pieces. For example, the connecting piece can be rectangular, and there are two connecting pieces including a left connecting piece and a right connecting piece and two adapting pieces. At this time, the core is welded on the first tongue, and then the adapting piece is welded with the second tongue of the connecting piece by ultrasonic. After the separated left and right connecting pieces (which can each occupy half of a welding area of the top cover) are aligned in their tops, the separated left and right connecting pieces are welded and fixed with the top cover by laser. Material utilization is 100%, and there is no redundant material to be removed. A laser welding area between an anode and/or cathode and the top cover is small, and th electron path is short, and materials are saved with a low cost, but it is not easy to form a fusing apparatus for the anode (due to limited space).

Moreover, in its process and taking preparation of a battery with a four-core structure as an example, if a U-shaped connecting piece is adopted, there are 12 ultrasonic weldings (two ultrasonic weldings of the adapting piece (two cores are welded on one adapting piece), one ultrasonic welding of the adapting piece and the connecting piece, as well as ultrasonic weldings for left and right structures of the positive and negative electrodes, totaling 12 ultrasonic weldings) and two laser weldings, in addition to ultrasonic pretreatment of the connecting piece (each connecting piece is subjected to one ultrasonic pretreatment, and four connecting pieces are subjected to total four ultrasonic pretreatments), and this ultrasonic process is complicated, and the more the ultrasonic weldings, the more the engineering requirements and the greater the possibility of introducing metal debris. With no additional connecting arm being provided, the four ultrasonic weldings of the adapting piece and the connecting piece can be completed separately, and a production process of four weldings of the connecting piece and the adapting piece can be removed (this process can be completed by a supplier or within a separate area in a company), and the ultrasonic process is greatly simplified.

Optionally, the adapting piece and the connecting piece are integrally formed as an integrally formed component. For example, both the connecting piece and the adapting piece are made of multi-layer materials, and the connecting piece is formed with a single-layer structure by molecular welding at a welding position with the top cover. The integrally formed adapting piece and connecting piece can be provided to be of a L-like structure. As the whole connecting assembly is a single structural member, four ultrasonic weldings can be reduced for a single core compared with the above-described separated structures of the adapting piece and the connecting piece, but introduction of the molecular welding device may lead to higher cost. In terms of processes, taking preparation of a battery with a four-core structure as an example, this scheme requires eight ultrasonic weldings and two laser weldings. However, it is noted in the two laser weldings that the positive or negative structural members each occupy half of a metal part of the top cover in laser welding, so as to align the connecting piece and improve quality of the laser welding. Too many ultrasonic weldings may easily lead to introduction of metal debris into the battery core, resulting in a large self-discharge voltage difference and seriously affect safety of the battery core.

A multi-core battery is further provided in another embodiment of the disclosure, which includes paired cores and a top cover, and the battery further includes any one of battery core connecting assemblies as described above. The paired cores are welded by small butterfly welding through the adapting piece, and the cores subjected to the small butterfly welding are finally welded with the top cover using large butterfly welding through the connecting piece. A butterfly welded core structure involves the small butterfly welding through the adapting piece and then the large butterfly welding with the connecting piece, which is firstly proposed in the industry.

The multi-core battery can be not only a wound-type lithium-ion battery, but also can be a stacked lithium-ion battery.

In an alternative embodiment, a manufacturing process of the stacked lithium-ion battery can be as follows: a core is formed by stacking and winding a separator, a negative electrode, a separator and a positive electrode, and dimensions and covering of the separator, the negative electrode and the positive electrode involves specific overhang requirements (an expression “overhang” refers to parts beyond the positive and negative electrode plates in length directions and width directions of the positive and negative electrode plates. Generally, in order to ensure that a corresponding surface of the positive electrode of the battery has a negative coating to receive lithium ions and prevent generation of lithium dendrites, it is required for the battery electrode plate that the negative electrode exceeds the positive electrode, and a size of the negative electrode plate is larger than that of the positive electrode; an excess area is called the Overhang; if alignment accuracy of a stacking or winding process is high, the excess area of the negative electrode can be reduced accordingly, thus reducing volume and weight of an excess part of the negative electrode, with high energy density), after pre-welding and trimming, positive and negative tabs are welded with the adapting piece using the small butterfly welding; then, a formed core A and core B are welded with the connecting piece using large butterfly ultrasonic welding, and the welded connecting piece (with the core) is laser welded with the top cover, and the core is formed by dispensing hot melt adhesive at a fused part of the positive connecting piece, gluing and insulating at an electrode metal, fastening the core using a Myra PP film after winding, hot stamping and fixing its top with a PP plate of the top cover, laser welding after inserting into an aluminum shell, drying, primary injecting, forming, secondary injecting, laser sealing a liquid injection port, capacity grading, aging, and encapsulating and attaching an insulating surface pad.

As an alternative embodiment, attachment of the positive electrode plate of the battery can be mainly made of any one or more of lithium iron phosphate (containing lithium manganese iron phosphate), ternary lithium nickel cobalt manganate (containing high nickel 811 and NCA), Li-rich manganese, lithium manganate, high-voltage LiNi0.5Mn0.5O4, sulfur and oxides thereof, layered sodium ion materials or prussian blue, prussian white, or the like. A covering support of the negative electrode is mainly made of any one or more of artificial graphite, natural graphite, mesocarbon microbead, soft carbon, hard carbon, lithium titanate, silicon and its oxide or silicon-carbon composite, tin-based alloy, nickel-based alloy, iron-based alloy and lithium metal. The separator can be any one or more of PP-based, PE-based or PP/PE composite materials, solid electrolyte, or the like. Electrolyte contains a base solvent of EC\EMC\DMC\DEC\PC, a solute of one or more of LiPF₆, LiTFSI, LiFSI, LiPF₂O₂, LiBOB and LiDFOB, and an additive of one or more of vinylene carbonate, fluoroethylene carbonate, bifluoroethylene carbonate, 1,3-propane sultone, 1,3-propylene sultone and methylene methanedisulfonate. Selections of materials for the anode, cathode, electrolyte, separator, etc. are not intended regarded as limitations on this disclosure.

To sum up, in the battery core connecting assembly and the multi-core battery according to the disclosure, the adapting piece and the connecting piece are skillfully combined, and the adapting piece has a multi-layer structure at the pliable part of the first tongue and the second tongue, and the connecting piece is welded with the top cover at a position of the single-layer structure, so that welding such as laser welding using easy bending of the multi-layer structure and easy use of the single-layer structure is with reliable connection and high material utilization of structural members. Defective rate of self-discharge voltage difference of the battery is less than 0.4%, and there is a risk that defective products are not picked out.

### BRIEF DESCRIPTION OF THE DRAWINGS

FIG. 1 is a perspective view of a positive adapting piece according to Embodiment 1 of the present disclosure;

FIG. 2 is a perspective view of a negative adapting piece according to Embodiment 1 of the present disclosure;

FIG. 3 is a front view of a negative adapting piece according to Embodiment 1 of the present disclosure;

FIG. 4 is a side view of a negative adapting piece according to Embodiment 1 of the present disclosure;

FIG. 5 is a schematic diagram of a positive connecting piece according to Embodiment 1 in this disclosure;

FIG. 6 is a sectional view taken along A-A in FIG. 5;

FIG. 7 is a schematic diagram of a positive connecting piece according to Embodiment 1 in this disclosure;

FIG. 8 is a sectional view taken along B-B in FIG. 7;

FIG. 9 is a schematic diagram of a positive electrode plate according to Embodiment 1 of the present disclosure;

FIG. 10 is a schematic diagram of a negative electrode plate according to Embodiment 1 of the present disclosure;

FIG. 11 is a front view of a pre-trimmed battery core according to Embodiment 1;

FIG. 12 is a side view of a pre-trimmed battery core according to Embodiment 1;

FIG. 13 is a top view of a pre-trimmed battery core according to Embodiment 1;

FIG. 14 is a front view of a battery core before pre-trimming according to Embodiment 1;

FIG. 15 is a side view of a battery core before pre-trimming according to Embodiment 1;

FIG. 16 is a schematic diagram of a battery core after small butterfly welding according to Embodiment 1;

FIG. 17 is a partial enlarged view of FIG. 16;

FIG. 18 is a partial side view of a structure shown in FIG. 16;

FIG. 19 is a schematic diagram of gluing the battery core in FIG. 16 after welding;

FIG. 20 is a schematic diagram of stacking and gluing of the battery core according to Embodiment 1;

FIG. 21 is a physical diagram of a pliable part being large butterfly welded according to Embodiment 1;

FIG. 22 is a schematic view of FIG. 21 after gluing;

FIG. 23 is a side view of FIG. 22;

FIG. 24 is a schematic view of a Mylar film according to Embodiment 1;

FIG. 25 is a sectional view taken along C-C in FIG. 24;

FIG. 26 is a partially enlarged view of a part I of FIG. 25;

FIG. 27 is an overall schematic diagram of a battery according to Embodiment 1;

FIG. 28 is a schematic view of the battery in FIG. 27 with a case, a top cover or the like being removed;

FIG. 29 is a schematic view of the battery in FIG. 28 with a pole, a positive connecting piece and a negative connecting piece being removed;

FIG. 30 is a schematic cross-sectional view of a battery core with a mylar film added after ultrasonic welding;

FIG. 31 is a cross-sectional view perpendicular to the cross-sectional view in FIG. 30;

FIG. 32 is a schematic diagram of large butterfly welding (laser welding) according to Embodiment 1;

FIG. 33 is a schematic side view of a structure in FIG. 32;

FIG. 34 is a schematic diagram of an insulating film added after the large butterfly welding;

FIG. 35 shows a positive connecting piece of another shape according to Embodiment 2;

FIG. 36 is a schematic view of a connecting piece according to Embodiment 3;

FIG. 37 is a three-dimensional physical diagram of a battery core connecting assembly according to Embodiment 3;

FIG. 38 is a schematic diagram of a battery core connecting assembly before and after the adapting piece is bent at a rounded corner according to Embodiment 3;

FIG. 39 is a schematic view of an arrangement direction of a rounded corner of the adapting piece according to Embodiment 3;

FIG. 40 is a schematic view of an adapting piece with a rounded corner in other directions according to other embodiments; and

FIG. 41 is a schematic diagram of matching of two assemblies of cores A and B according to Embodiment 3.

### DETAILED DESCRIPTION

In order to make the above and other objects, features and advantages of the disclosure more obvious and understandable, a detailed description is made below for the preferred embodiments with reference to the accompanying drawings.

Laser welding in the following embodiments can be replaced with other welding in some cases, such as ultrasonic welding. Ultrasonic welding in following embodiments can be replaced with other welding in some cases, such as laser welding.

### Embodiment 1

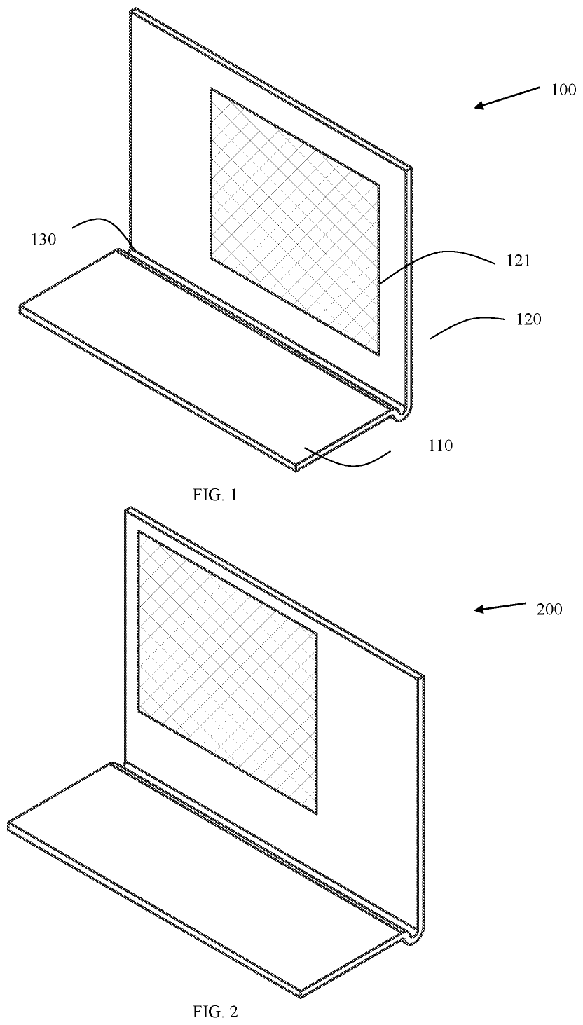

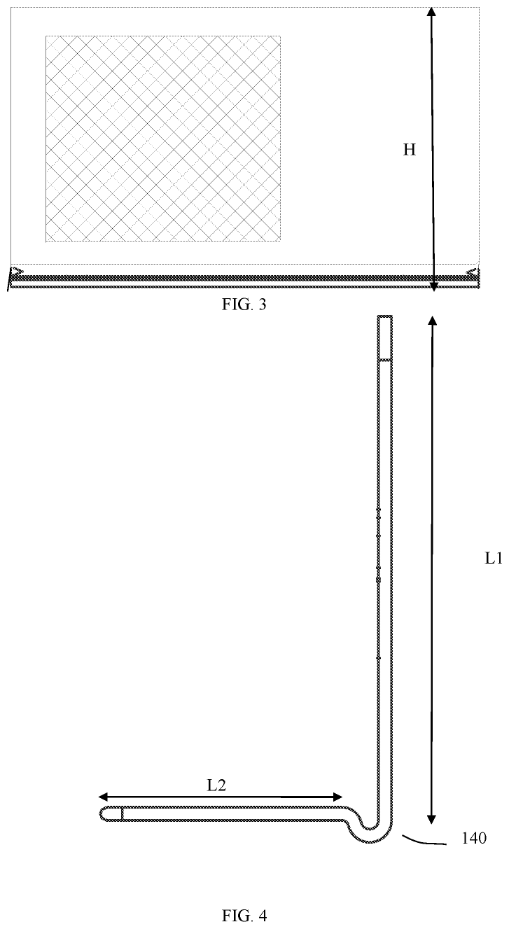

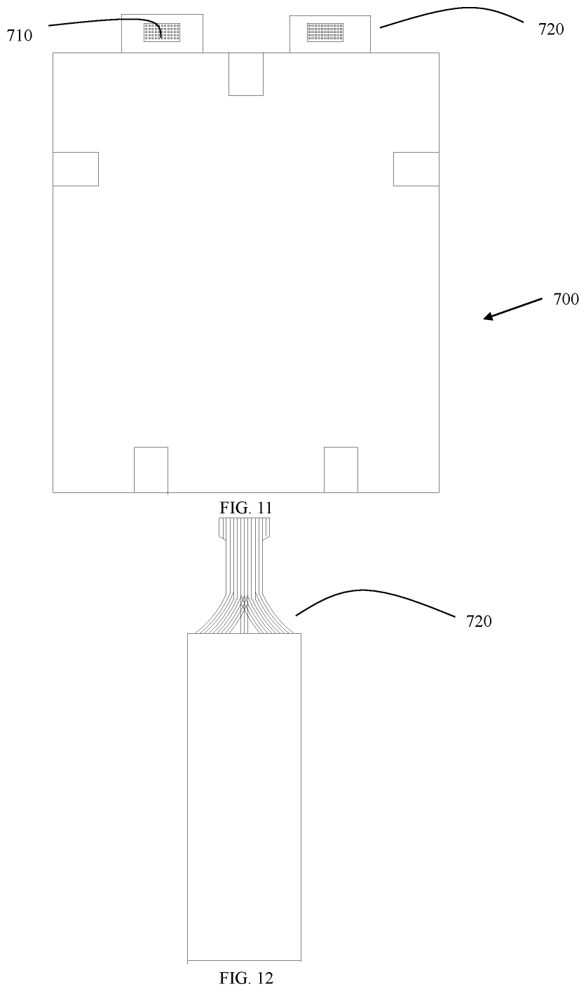

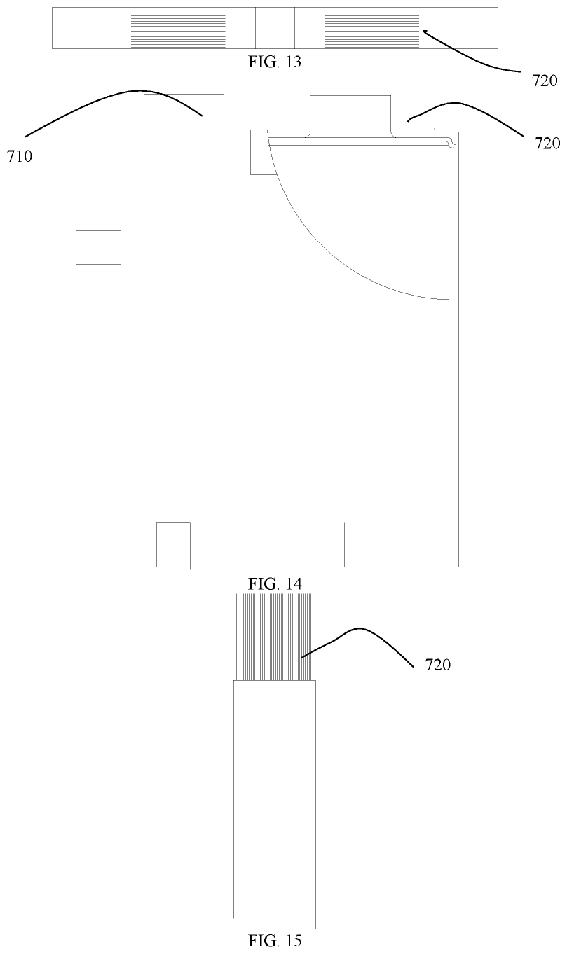

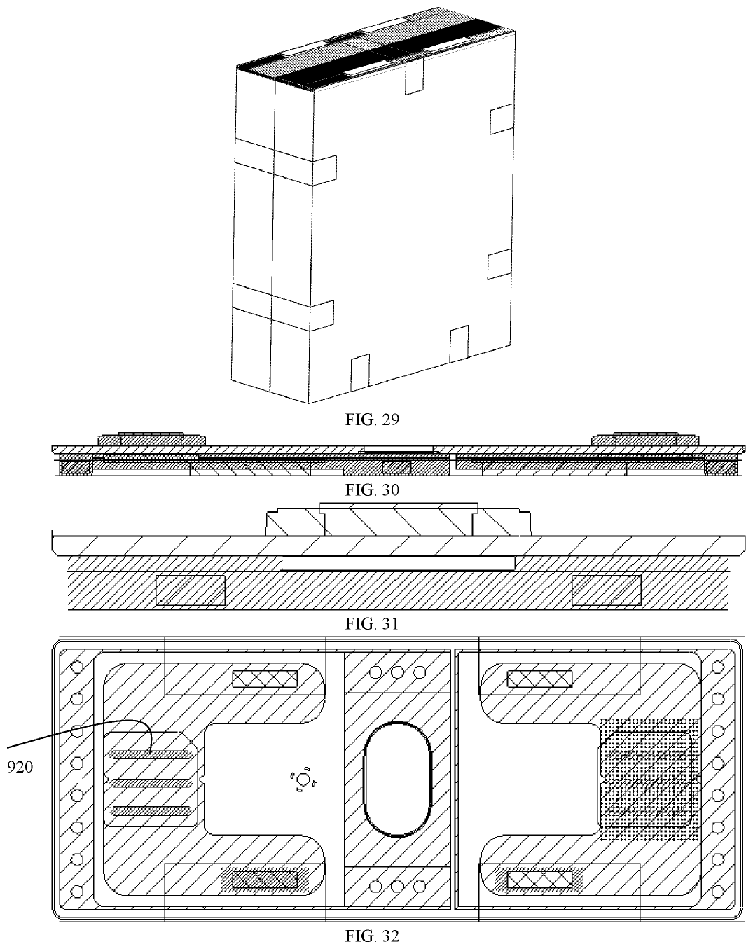

Referring to FIGS. 1 to 34, a battery core connecting assembly and a multi-core battery 900 including the connecting assembly are provided in Embodiment 1.

The battery core connecting assembly is configured for connecting a core of a lithium-ion battery. The lithium-ion battery includes a top cover 901, and the battery core connecting assembly includes an adapting piece and a connecting piece which at least in part includes a single-layer structure. The adapting piece includes a first tongue 120 and a second tongue 110 which are connected with each other, the first tongue is configured to be welded with the core, the adapting piece is pliable at a pliable part 130 of the first tongue and the second tongue, and the adapting piece has a multi-layer structure at least at the pliable part. The connecting piece is connected with the second tongue of the adapting piece, and the connecting piece is welded with the top cover at a position of the single-layer structure.

An adapting piece in the positive battery core connecting assembly is a positive adapting piece 100, and a connecting piece in the positive battery core connecting assembly is a positive connecting piece 300. Correspondingly, an adapting piece in the negative battery core connecting assembly is a negative adapting piece 200, and a connecting piece in the negative battery core connecting assembly is a negative connecting piece 400.

In this embodiment, the adapting piece and the connecting piece are independent of each other, and the connecting piece has a single-layer structure and the adapting piece plate has a multi-layer structure.

As shown in FIG. 1 to FIG. 4, the adapting piece is of a multi-layer wound structure (which is shaped after a sheet is rolled and flattened), and the adapting piece is L-shaped. The positive adapting piece includes 8 layers*0.1 mm and the negative adapting piece includes 6 layers*0.1 mm. In other embodiments, the positive adapting piece can also includes 6 layers*0.1 mm and the negative adapting piece includes 4 layers*0.1 mm. That is to say, a thickness of the single-layer positive adapting piece can be the same as that of the negative adapting piece, and a number of layers of the positive adapting piece can be different from that of the negative adapting piece, for example, the number of layers of the positive adapting piece can be more than that of the negative adapting piece. Although a thickness of each layer of the positive and negative adapting pieces in this embodiment is 0.1 mm, which is not limited in this disclosure, and in other embodiments, it can be 0.05 mm, 0.2 mm or the like.

In order to reduce stress concentration after bending, the first tongue and the second tongue can be provided with a rounded corner 140 at the pliable part. In this embodiment, diameters of the rounded corners of the positive and negative adapting pieces are the same, which are all 1.2 mm and 1.5 times a thickness of the positive adapting piece and 2 times a thickness of the negative adapting piece. In other embodiments, the diameters of the rounded corners of the positive and negative adapting pieces may be different.

Optionally, the positive electrode adapting piece can be made of 1060 aluminum, and the negative electrode adapting piece can be made of T2 copper.

A mesh area in the figures is a welding area 121 for welding with a electrode plate, and its position is set according to a position of the electrode plate and welding requirements. Before welding, the welding area is partially or wholly subjected to ultrasonic treatment, so as to ensure tight connection between layers of the multi-layer structure and ensure welding with a tab group of the battery core to be firm and without cold joints.

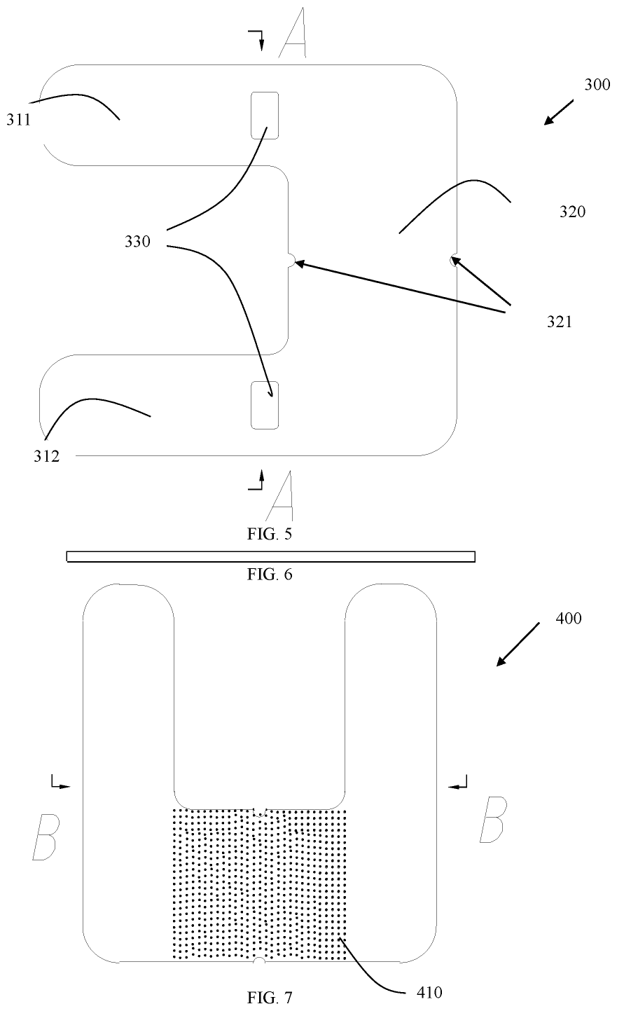

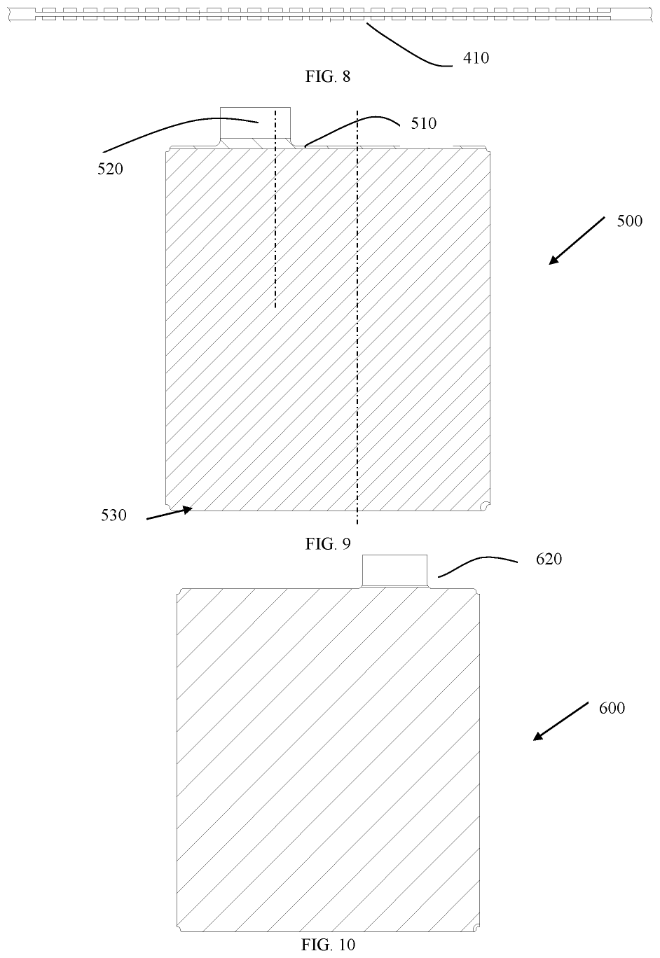

The connecting piece in this embodiment is of a single-layer U-shaped structure, including a connecting piece body 320 and two connecting arms (311, 312). As shown in FIGS. 5 to 8, the U-shape structure can be used to accommodate other components. A laser welding area (located in the connecting piece body) is large, which facilitates firm welding. Using laser welding and because positions between the connecting piece body 320 and the connecting arms for connecting with the second tongue are staggered, the whole connecting piece body can be reserved, and there is enough space for a U-shaped part of the positive electrode to be fused. FIGS. 5 and 6 show the positive connecting piece, and FIGS. 7 and 8 show the negative connecting piece. A thickness of the positive connecting piece is 0.6 mm and it is made of 1060 aluminum. A thickness of the negative connecting piece is 0.4 mm, and the negative electrode is made of T2 copper. Although the positive and negative connecting pieces can be made of a same material as the positive and negative adapting pieces, the connecting piece can optionally be harder than the adapting piece. For example, tensile strength, hardness and elongation of the positive connecting piece can be higher than that of the positive adapting piece, elongation after fracture of the positive connecting piece can be lower than that of the positive adapting piece, and tensile strength and hardness of the negative connecting piece can be higher than that of the negative adapting piece, and elongation of the negative connecting piece can be lower than that of the negative adapting piece.

However, thicknesses and materials are not limited in this disclosure. A U-shaped bottom of the positive connecting piece (a position where the connecting arms and the connecting piece body are connected) is provided with a fusing and arc extinguishing apparatus 330, which ensures fusing and arc extinguishing in a case of a load-cutting extreme short circuit (with a current more than 1800 A for 10 S) when meeting requirements of current carrying and temperature rise of large magnification (2 C to 4 C). The arc extinguishing apparatus is a pore-filled epoxy resin hot-melt injection plastic piece, and the positive and negative electrodes are insulated by attaching a PET tape after laser welding. A laser welding area of the negative connecting piece in a main body area of the connecting piece is a laser welding pockmark area 410, for preventing a problem of cold joints caused by high-intensity reflection of laser in laser welding.

Optionally, two opposite sides of the positive and negative connecting piece bodies can be provided with an inward concave groove 321, which can be engaged with a corresponding structural pin at a corresponding positions on the top cover, thus realizing positioning and fixing functions.

FIGS. 9 and 10 respectively show a positive electrode plate 500 and a negative electrode plate 600 according to the present disclosure. The positive electrode plate includes a positive tab 520, and the negative electrode plate includes a negative tab 620. Optionally, the positive tab is shifted to one side of the positive electrode plate and the negative tab is shifted to the other side of the negative electrode plate (opposite to the side where the positive tab is shifted).

Optionally, the positive electrode plate in this embodiment is rectangular in shape, and the tabs are also rectangular. Both the positive electrode plate 500 and the negative electrode plate 600 have a central axis. A primary central axis of the positive electrode plate is shown by a long dot-dash line in the figure, and a short dot-dash line indicates a secondary central axis of the positive electrode plate, that is, a central axis of a part at a left side of the primary central axis. The central axis in this embodiment is a central symmetry line. In other embodiments, for example, if the electrode plate is in an asymmetric pattern, the central axis is a line passing through a midpoint of the wide side and perpendicular to a wide side, and when the wide side is uneven and non-linear, this line can be not perpendicular to the wide side, as long as it can serve to roughly distinguish connection areas of the positive tabs and the negative tabs. Of course, in some electrode plates with central symmetry, the central axis may not be a center line of symmetry, as long as it can serve to roughly distinguish areas for connecting the positive tabs and the negative tabs at a top side of the tab.

An expression “the positive tab is shift to one side of the positive electrode plate” means that the positive tab is located at one side of the primary central axis, but the positive lug is closer to the primary central axis than the secondary central axis, and the negative electrode plate can refer to the positive electrode plate.

Optionally, chamfers 530 are provided at four corners of the positive electrode plate and the negative electrode plate, and the chamfers have a wavy structure.

Optionally, a top side of the positive electrode is provided with a ceramic insulating layer 510, and a connection area between the positive tab and the positive electrode plate is not provided with the ceramic insulating layer, which indicates that the positive tab passes through the ceramic insulating layer to be connected with a main body of the positive electrode plate. A thickness of the ceramic insulating layer is from 0.5 mm to 8 mm, which functions in insulation protection, so as to prevent positive die-cutting burr (insulation ceramic protection) of this electrode plate from contacting with other negative electrodes in the future, and avoid short circuit and fire caused by a bare aluminum foil contacting a negative SEI interface film. If the thickness of the ceramic insulating layer is provided to be too large and exceeds a thickness of an electrode film, a thickness of the charging and discharging unit may be caused to increase, which will be difficult to be assembled into a case, thus squeezing the separator and being short-circuited.

In other embodiments, the positive tab and the negative tab can also be located at a position of the secondary central symmetry axis, or two positive tabs can be arranged on a same positive electrode plate, and two negative tabs can be arranged on a same negative electrode plate, and the two positive tabs and two negative tabs are shifted to both sides of the electrode plate.

As shown in FIGS. 11 to 15, the core 700 in this disclosure has a stacked structure, which is formed by sequentially stacking and winding a diaphragm, a negative electrode, a diaphragm and a positive electrode. In FIG. 14, a pre-welded and trimmed tab group (including a positive tab group 710 and a negative tab group 720) is located in a middle of the side view. Optionally, the positive electrode is side coated with ceramic and PVDF glue to prevent internal short circuit caused by contacting of aluminum burr of the positive electrode and electrons of the negative electrode.

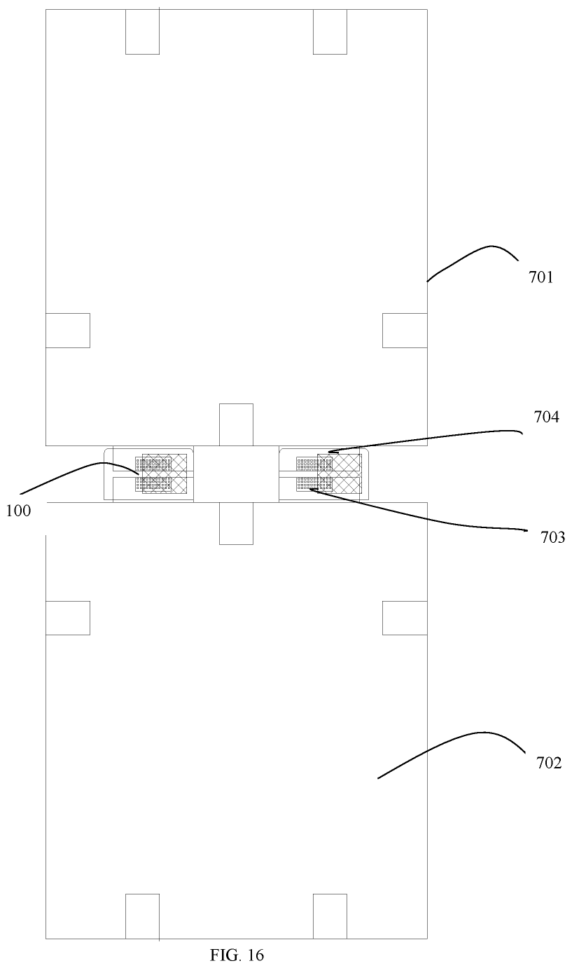

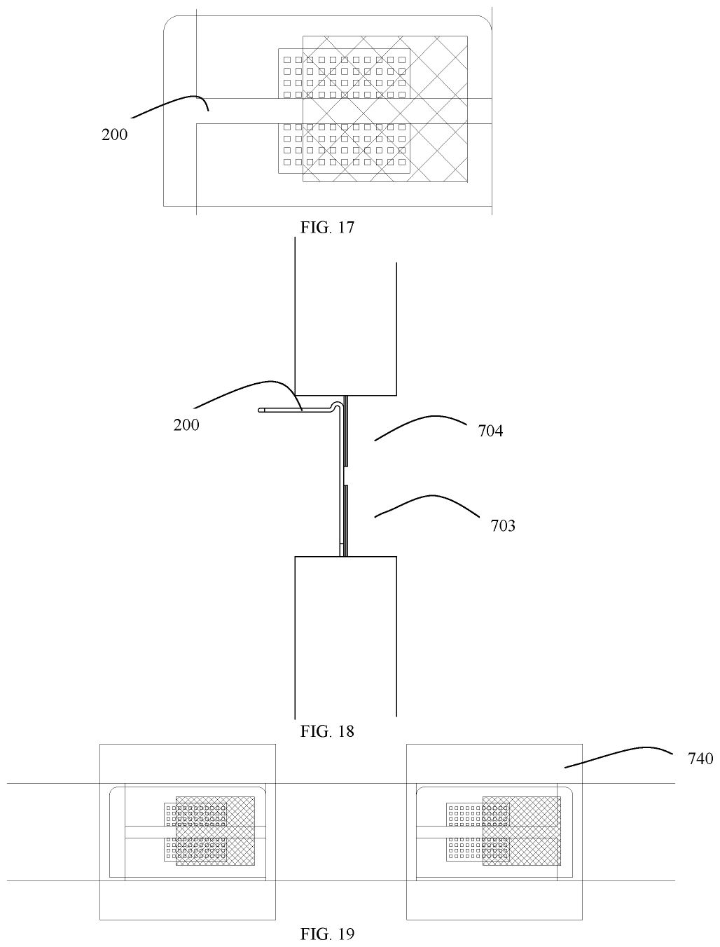

As shown in FIGS. 16 to 18, the physical diagram of small butterfly welding are shown. In FIG. 16, there are two cores (701, 702) in the core A, which are welded through the positive adapting piece 100 and the negative adapting piece 200. A first tongue of the positive adapting piece is welded with the positive tabs of the two cores respectively, and a first tongue of the negative adapting piece is welded with the negative tabs (703, 704) of the two cores respectively. A welding area of the positive adapting piece corresponds to a welding area of the positive tab of the core, as shown in FIG. 17.

Optionally, the first tongue and the second tongue form a rounded corner after being bent at the pliable part, and a central angle corresponding to the rounded corner is 180 degrees, and the rounded corner protrudes toward one side of the second tongue, which facilitates bending and provides enough contact area for connection with the tab, but may affect a height h of the whole adapting piece. Optionally, a length L1 of the first tongue of the adapting piece is longer than a length L2 of the second tongue, which further provides enough contact area for connection with the tabs.

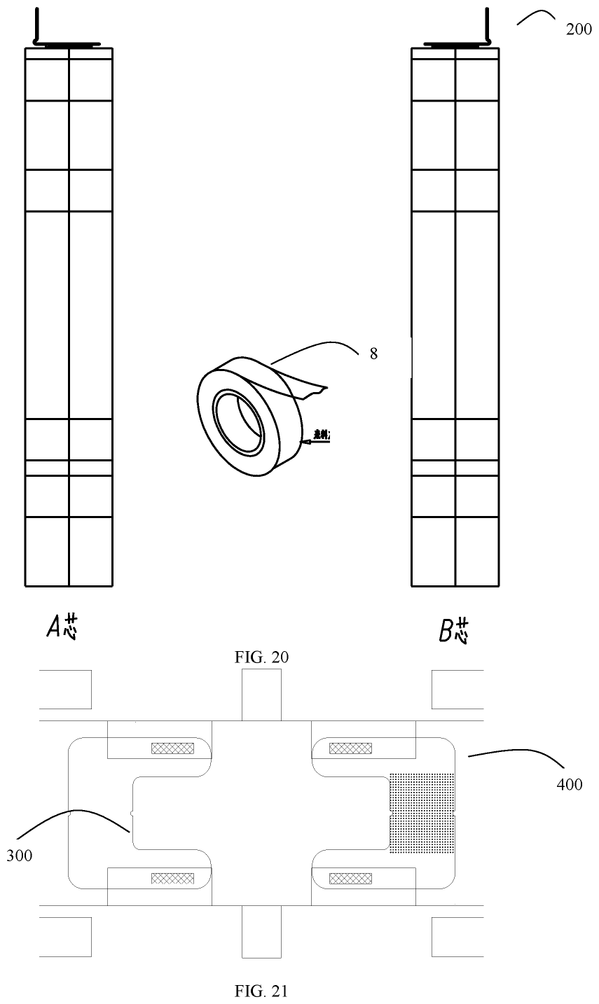

FIG. 19 shows a schematic diagram of gluing of a tab 704 after the small butterfly welding, and gluing is made on a side away from the adapting piece. The stacked cores are also glued with a tape 8 to form cores A and B respectively, as shown in FIG. 20. The adapting piece in a same core A are arranged in a same direction, and so is the core B.

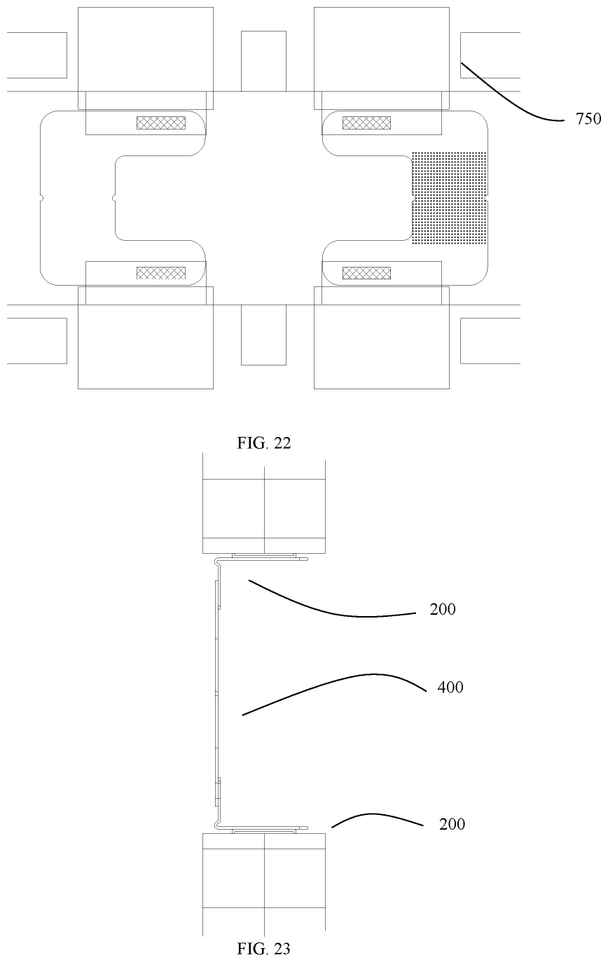

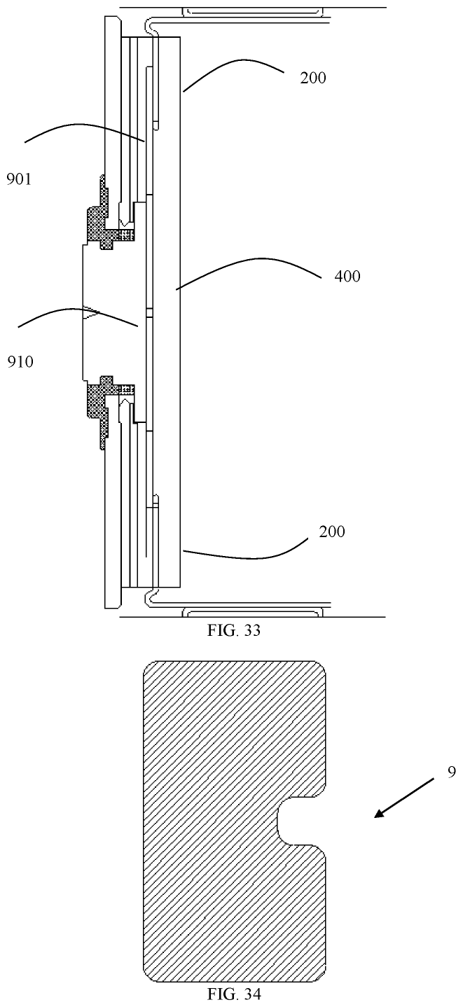

In this embodiment, the core is of a four-core butterfly welding structure, and the core A and the core B are mirror-symmetrical, and are characterized in that the small butterfly welding and the large butterfly welding. The two cores are ultrasonic welded (small butterfly welded) in parallel by the positive and negative adapting pieces and wound, and then are ultrasonic welded (large butterfly welded) with the top cover and the connecting piece respectively. In the large butterfly welding, the core A and the core B are bent against each other, and its bending direction is required to cause the connecting piece to expose to facilitate welding with the top cover; and in bending, the second tongue is just bent along the rounded corner to be roughly parallel to the first tongue. The top cover includes a pole 910, as shown in FIGS. 28 and 33. The two connecting arms of the positive connecting piece are respectively welded with the second tongues of the core A and the core B in parallel, and so is the negative connecting piece, as shown in FIG. 21. The tab 750 is glued after welding, as shown in FIG. 22, finally forming a structure of an electrode plate of the core A-the first tongue of the adapting piece of the core A-the second tongue of the adapting piece of the core A-the connecting arm of the connecting piece-another connecting arm of the connecting piece-the second tongue of the adapting piece of the core B-the first tongue of the adapting piece of the core B-an electrode plate of the core B. The whole four cores are in a parallel structure, and the tab group is drained to the pole of the top cover through the adapting piece and the connecting piece.

FIG. 32 shows a schematic diagram after laser welding. After laser welding on 920, an insulating PET film as shown in FIG. 34 is attached to it, and a groove 9 is provided at a side of the insulating PET film away from a battery edge for bending.

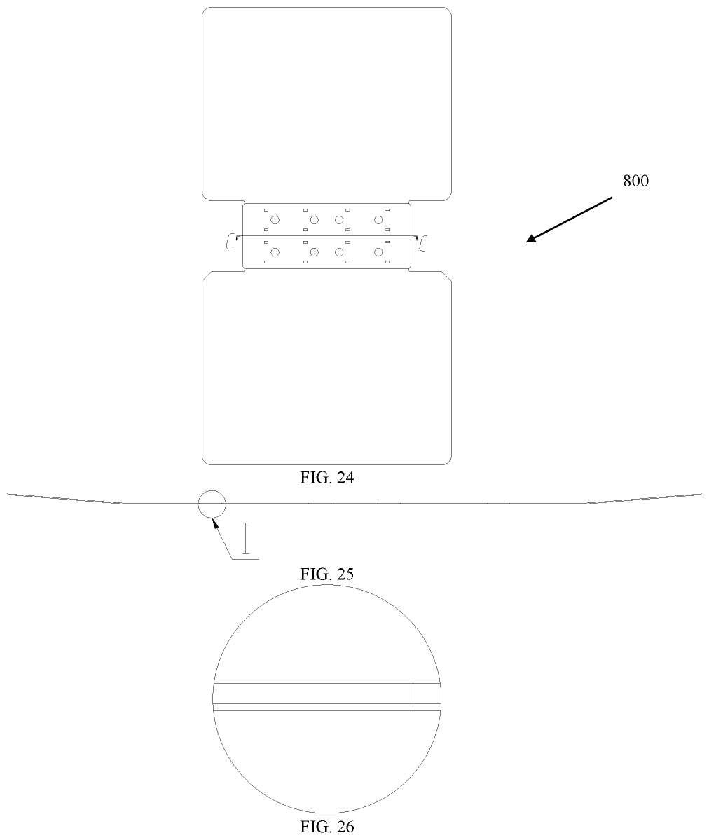

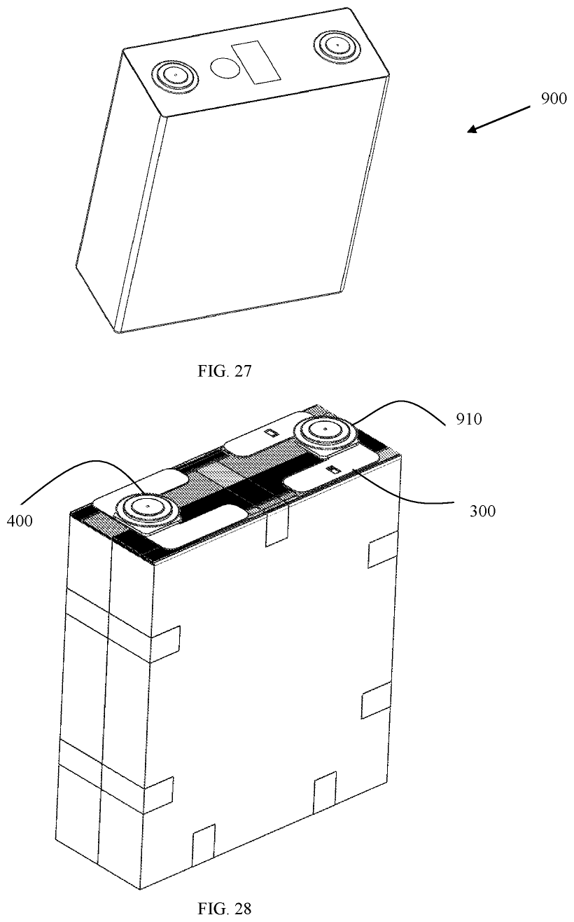

After the large butterfly welding, the battery core is formed by being coated with the mylar film 800 as shown in FIG. 24, and hot stamping of the top and then welding after inserting in the shell, primary injecting after being baked in a hot box, forming, secondary injecting, sealing a liquid injection port, and encapsulating and attaching an insulating surface pad on the top, as shown in FIG. 27. The mylar film serves for insulation and protection outside the core, and the top is hot stamped and fused to ensure that the mylar film is integral with the top cover.

The battery in this embodiment can be prepared as follows: after pre-welding and trimming, positive and negative tabs are welded with the adapting piece using the small butterfly welding, and a bending direction of the butterfly welding is required to cause the connecting piece to expose to facilitate welding with the connecting piece. Then a formed core A and core B are welded with the connecting piece using large butterfly ultrasonic welding, and the welded connecting piece (with the core) is laser welded with the top cover, and the core is formed by dispensing hot melt adhesive at a fused part of the positive connecting piece, gluing and insulating at an electrode metal, fastening the core using a Myra PP film after winding, hot stamping and fixing its top with a PP plate of the top cover, laser welding after inserting into an aluminum shell, drying, primary injecting, forming, secondary injecting, laser sealing a liquid injection port, capacity grading, aging, and encapsulating and attaching an insulating surface pad.

Optionally, a side edge of the core (in a non-tab extending direction, perpendicular to a tab extending direction) is subjected to hot stamping. After hot stamping and cooling, the separator adheres and fix the electrode plate to prevent left and right displacement, so as to ensure fixing of the side edge of the electrode plate and insulating of the side edge.

In its process and taking preparation of a battery with a four-core structure as an example, if a U-shaped connecting piece is adopted, there are 12 ultrasonic weldings (two ultrasonic weldings of the adapting piece (two cores are welded on one adapting piece), one ultrasonic welding of the adapting piece and the connecting piece, as well as ultrasonic weldings for left and right structures of the positive and negative electrodes, totaling 12 ultrasonic weldings) and two laser weldings, in addition to ultrasonic pretreatment of the connecting piece (each connecting piece is subjected to one ultrasonic pretreatment, and four connecting pieces are subjected to total four ultrasonic pretreatments), and this ultrasonic process is relatively complicated.

### Embodiment 2

Except a shape of the connecting piece, the battery core connecting assembly according to Embodiment 2 has same other structures and shapes as Embodiment 1, which will not be repeatedly described herein again. As shown in FIG. 35, an area of the connecting piece body of the connecting piece according to this embodiment is relatively larger than that according to Embodiment 1 so as to increase the welding area. The connecting piece in this embodiment can be regarded to be obtained by providing a rectangular connecting piece with a groove 10 inward along an edge of the rectangle, and the groove can be configured to accommodate other structural components.

### Embodiment 3

Except a shape of the connecting piece, the battery core connecting assembly according to Embodiment 3 has same other structures and shapes as Embodiment 1, which will not be repeatedly described herein again.

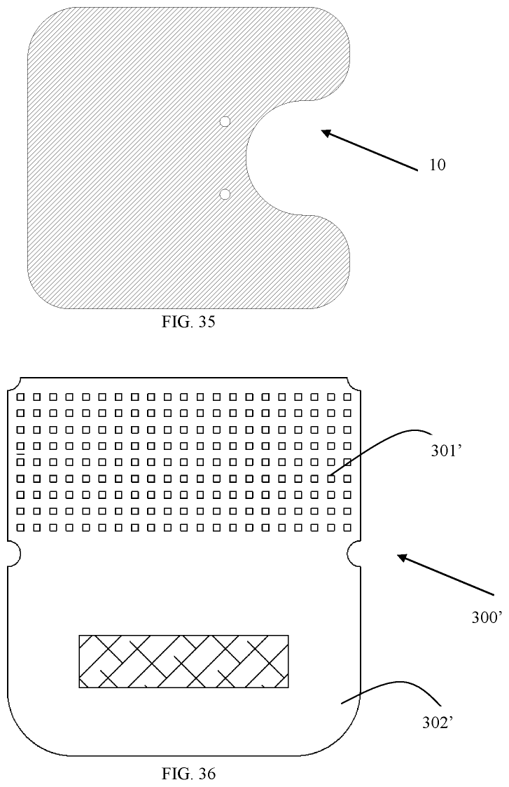

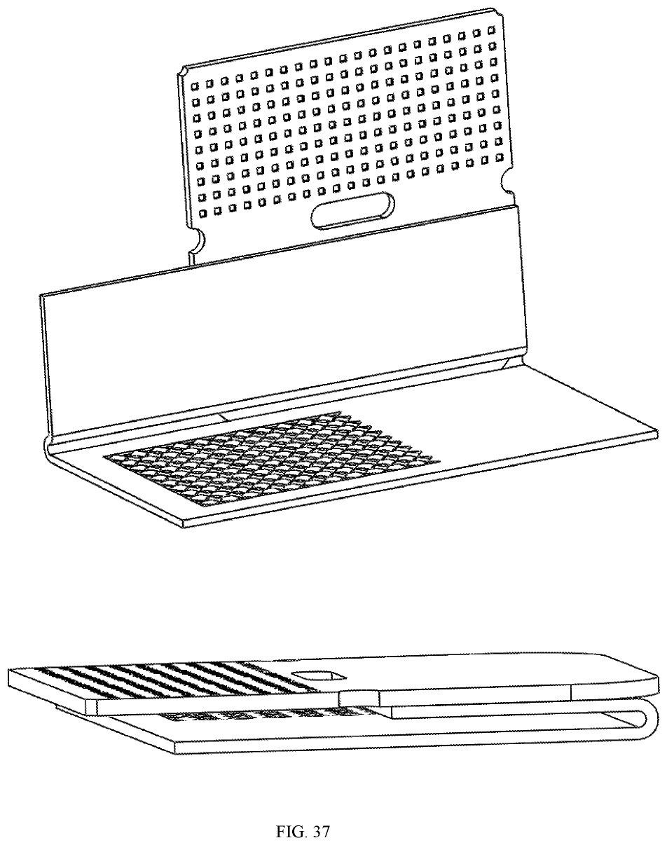

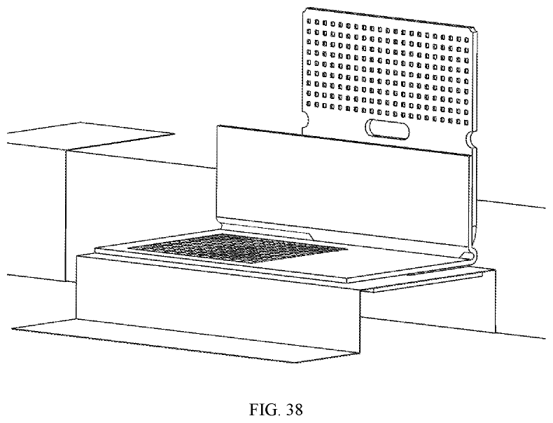

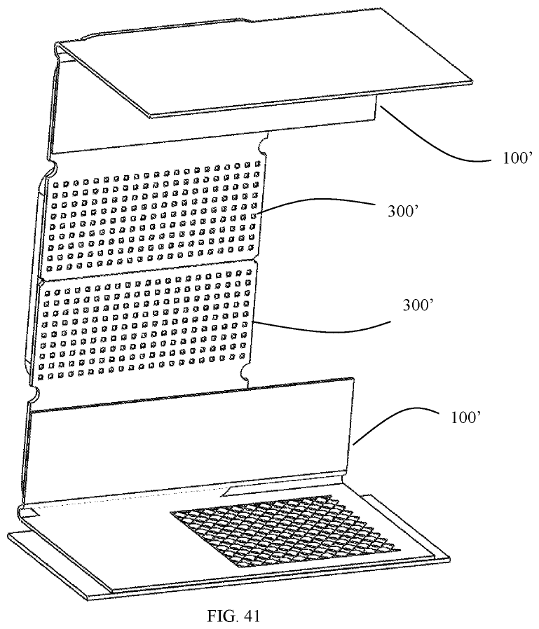

As shown in FIG. 36 to FIG. 38, the connecting piece may not be provided with additional connecting arms, and connecting pieces at this time may be in one-to-one correspondence to adapting pieces. In this embodiment, two positive connecting pieces and two negative connecting pieces are needed. The connecting piece 300′ in this embodiment includes an ultrasonic welding part 301′ for welding with the top cover and a welding part 302′ for welding with the adapting piece. Ultrasonic welding parts of the two connecting pieces 100′ respectively corresponding to cores A and B are arranged opposite to each other so as to weld with the top cover. As shown in FIG. 41, the two connecting pieces can abut against each other, and in other implementations, they may not abut against each other, as long as a distance therebetween is close enough for the top cover to be welded with the two connecting pieces. A through hole can be provided between the two parts, and a chamfer can be provided on the welding part. As shown in a second pane of FIG. 37, after secondary butterfly welding, the second tongue of the adapting piece rotates and bends along the rounded corner, and the first tongue and the second tongue are approximately in parallel.

Optionally, a width of the second tongue of the adapting piece can be larger than that of the connecting piece, so as to leave space for other components when the second tongue are welded with the adapting piece. Optionally, the corresponding two connecting pieces can be arranged at a same side of the second tongue, that is to say, the two second tongues and two connecting pieces can also form a U-shaped structure, so as to leave space for other components.

In other embodiments, the connecting piece can be rectangular or a combination of rectangular shape and semi-circular shape, and there are two connecting pieces including a left connecting piece and a right connecting piece and two adapting pieces. At this time, the core is welded on the first tongue, and then the adapting piece is welded with the second tongue of the connecting piece by ultrasonic. After the separated left and right connecting pieces (which can each occupy half of a welding area of the top cover) are aligned in their tops, the separated left and right connecting pieces are welded and fixed with the top cover by laser. Material utilization is 100%, and there is no redundant material to be removed. A laser welding area between an anode and/or cathode and the top cover is small, and th electron path is short, and materials are saved with a low cost, but it is not easy to form a fusing apparatus for the anode (the connecting piece is required to leave space for connecting with the second tongue and also serve as a fusing apparatus, with limited space).

Taking preparation of a battery with a four-core structure as an example, with no additional connecting arm being provided, the four ultrasonic weldings of the adapting piece and the connecting piece can be completed separately, and a production process of four weldings of the connecting piece and the adapting piece can be removed (this process can be completed by a supplier or within a separate area in a company), and the ultrasonic process is greatly simplified.

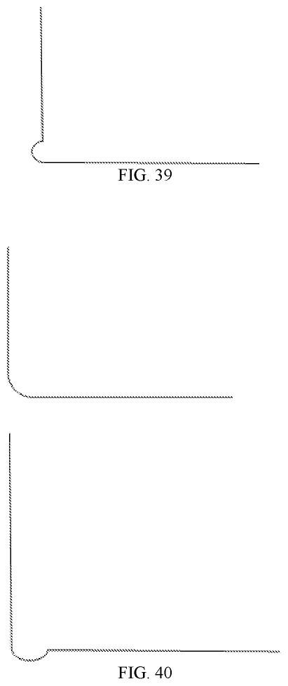

FIG. 39 shows an arrangement direction of the rounded corner of the adapting piece in this embodiment, which protrudes outward relative to the first tongue, and is similar to that in Embodiment 1, which facilitates bending of the adapting piece. However, as shown in FIG. 40, the first tongue and the second tongue are directly tangent to the rounded corner, or the rounded corner protrudes outward with respect to the second tongue.

### Embodiment 4

Except the connecting piece and the adapting piece are integrally formed or not, the battery core connecting assembly in Embodiment 4 has same other structures and shapes as Embodiment 1, which will not be repeatedly described herein again. Differences will be explained below. The adapting piece and the connecting piece provided in this embodiment are integrally formed. Both the connecting piece and the adapting piece are made of multi-layer materials, and the connecting piece is formed with a single-layer structure by molecular welding at a welding position with the top cover. The integrally formed adapting piece and connecting piece can be provided to be of a L-like structure. As the whole connecting assembly is a single structural member, four ultrasonic weldings can be reduced for a single core compared with the above-described separated structures of the adapting piece and the connecting piece, but introduction of the molecular welding device may lead to higher cost. In terms of processes, taking preparation of a battery with a four-core structure as an example, this scheme requires eight ultrasonic weldings and two laser weldings. However, it is noted in the two laser weldings that the positive or negative structural members each occupy half of a metal part of the top cover in laser welding, so as to align the connecting piece and improve quality of the laser welding. Too many ultrasonic weldings may easily lead to introduction of metal debris into the battery core, resulting in a large self-discharge voltage difference and seriously affect safety of the battery core.

### Embodiment 5

A battery core connecting assembly with a relatively simple structure can be provided in Embodiment 5. The battery core connecting assembly is configured for connecting a core of a lithium-ion battery. The lithium-ion battery includes a top cover, and the battery core connecting assembly includes an adapting piece and a connecting piece which at least in part includes a single-layer structure. The adapting piece includes a first tongue and a second tongue which are connected with each other, the first tongue is configured to be welded with the core, the adapting piece is pliable at a pliable part of the first tongue and the second tongue, and the adapting piece has a multi-layer structure at least at the pliable part. The connecting piece is connected with the second tongue of the adapting piece, and the connecting piece is welded with the top cover at a position of the single-layer structure.

The adapting piece and the connecting piece are skillfully combined, and the adapting piece has a multi-layer structure at the pliable part of the first tongue and the second tongue, and the connecting piece is welded with the top cover at a position of the single-layer structure, so that welding such as laser welding using easy effective bending of the multi-layer structure and easy use of the single-layer structure of the connecting piece is with reliable connection and high material utilization of structural members.

### Embodiment 6

In this embodiment, except a diameter of the rounded corner, other structures and shapes are the same as Embodiment 1, which will not be repeatedly described herein again. In this embodiment, diameters of the rounded corners of the positive and negative adapting pieces are the same, which are all 0.75 mm and 0.9375 times the thickness of the positive adapting piece and 1.25 times the thickness of the negative adapting piece. In this embodiment, the diameter of the positive connecting piece is set too small, and stress after bending is not well dispersed. After using for a period of time, the positive connecting piece is easy to break at the pliable part, resulting in loss of basic functions.

### Embodiment 7

In this embodiment, except a diameter of the rounded corner, other structures and shapes are the same as Embodiment 1, which will not be repeatedly described herein again. In this embodiment, diameters of the rounded corners of the positive and negative adapting pieces are the same, which are all 0.75 mm and 0.9375 times the thickness of the positive adapting piece and 1.25 times the thickness of the negative adapting piece.

### Embodiment 8

In this embodiment, except a diameter of the rounded corner, other structures and shapes are the same as Embodiment 1, which will not be repeatedly described herein again. In this embodiment, diameters of the rounded corners of the positive and negative adapting pieces are the same, which are all 1 mm and 1.25 times the thickness of the positive adapting piece and 5/3 times the thickness of the negative adapting piece.

### Embodiment 9

In this embodiment, except a diameter of the rounded corner, other structures and shapes are the same as Embodiment 1, which will not be repeatedly described herein again. In this embodiment, diameters of the rounded corners of the positive and negative adapting pieces are the same, which are all 1.5 mm and 1.875 times the thickness of the positive adapting piece and 2.5 times the thickness of the negative adapting piece.

### Embodiment 10

In this embodiment, except a diameter of the rounded corner, other structures and shapes are the same as Embodiment 1, which will not be repeatedly described herein again. In this embodiment, diameters of the rounded corners of the positive and negative adapting pieces are the same, which are all 2 mm and 2.5 times the thickness of the positive adapting piece and 10/3 times the thickness of the negative adapting piece. A diameter of the negative connecting piece in this embodiment is too large, which affects a height after bending.

### Embodiment 11

Different from Embodiment 1, a thickness of each layer of the adapting piece in this disclosure is reduced to 0.05 mm, but a total number of layers is increased so that a total thickness is the same as that in Embodiment 1. It is equivalent to increasing a number of layers of the tab group of the battery, which increases welding difficulty and a risk of introducing debris.

### Embodiment 12

Different from Embodiment 1, a thickness of each layer of the adapting piece is unchanged and the number of layers is increased, for example, a number of layers of the positive adapting piece is increased to 9, and a number of layers of the negative connector is increased to 7, with an increased total thickness. Finally, bending processing is more difficult.

### Embodiment 13

A thickness of each layer of the adapting piece is unchanged and the number of layers is decreased, for example, a number of layers of the positive adapting piece is decreased to 5, and a number of layers of the negative connector is decreased to 3, with a decreased total thickness. Finally, overcurrent capacity of the connecting piece is reduced, rate capability of the battery core is reduced, and heat generation is increased.

### Embodiment 14

A total thickness of the adapting piece is the same as in Embodiment 1, but a thickness of each layer is increased to 0.21 mm, and a number of layers is reduced. When a thickness of a single layer is increased, it will be too hard and it is easy to crack in ultrasonic welding.

### Comparative Embodiment 1

The connecting piece in this comparative embodiment is a single-layer connecting piece with no adapting piece provided. The connecting piece is bent in an L shape. The thickness of the positive connecting piece is 0.8 mm, and the thickness of the negative connecting piece is 0.6 mm. However, it is difficult for a single layer to bend effectively in bending, and there is no place to release stress at a bend, so it is easy to break at the bend under extreme conditions, such as vibration and impact, which leads to degraded performance.

### Comparative Embodiment 2

It has also be tried to operate directly with the same adapting piece as in Embodiment 1 without providing the connecting tab. Only difference is illustrated in the following. The adapting piece is multi-layered, the total thickness of the adapting piece of the positive electrode is 0.6 mm and the thickness of the adapting piece of the negative electrode is 0.4 mm, and both the positive and negative adapting pieces are L-shaped, and the L-shaped positive and negative adapting pieces involve two ultrasonic treatments, their bottoms are welded with the core by ultrasonic treatment, and their tops are subjected to ultrasonic pretreatment for laser welding with the top cover. Material utilization is high and the L-shape structure is easy to bend. However, when the top is laser welded, a problem of cold joints is prone to occurring in the laser welding for the multi-layer connection, although with ultrasonic pretreatment. The cold joints may lead to high content heating of the battery core and even connection failure, with reduced reliability. Disadvantage is that unreliable laser welding in the laser welding of the top multi-layered adapting piece and the top cover may be caused due to pores between layers in the multi-layer structure, and the connection failure results in loss of functions.

Taking preparation of a battery with a four-core structure as an example, each structural member needs two ultrasonic pretreatments, resulting in eight ultrasonic weldings. Welding of a single connecting piece and the two cores needs two weldings, resulting in total eight weldings, the connecting piece and the adapting piece were welded using four ultrasonic weldings, and the top was welded using two laser weldings. However, it is noted in the two laser weldings that the positive or negative structural members each occupy half of a metal part of the top cover in laser welding, so as to align the connecting piece and improve quality of the laser welding. Meanwhile, because the connecting piece is multi-layered, there is still possibility of cold joints even after being subjected to ultrasonic pretreatment.

### Comparative Embodiment 3

The connection is made by one butterfly welding, and the cores on both sides of butterfly welding are directly ultrasonically welded at left and right through the positive and negative single-layer connecting pieces (the thickness of the positive electrode is 0.8 mm and the thickness of the negative electrode is 0.6 mm). The connecting pieces are planar, and there are no special-shaped structural member, so the structure is simple and there may be single core or multiple cores on both sides.

Compared with schemes of the disclosure and with a same number of layers of cores, a protruding length of a tab of the core increased by 10%˜30%; and meanwhile, welding power is increased due to doubled welding levels at a single electrode, and probability of metal debris being generated and mixed into a battery core is increased; and ultrasonic welding with an excessive frequency affects service life of an ultrasonic welding head and reduces reliability of the ultrasonic welding.

Taking preparation of a battery with a four-core structure as an example, four ultrasonic weldings (totaling four ultrasonic weldings for the cores and the connecting pieces) and two laser weldings (laser weldings for the positive and negative connecting pieces and the top cover) are needed.

When there are too many layers for positive and negative electrodes (equal to or more than 100 layers for both the positive and negative electrodes), service life for 8 Kw ultrasonic welding may be reduced and more metal debris can be produced, which results in introduction of debris. Compared with the scheme of Comparative Embodiment 2, it is more difficult to be welded for doubled number of layers, and it is an economical and effective way only for a small number of layers (equal to or less than 70 layers for the positive and negative electrodes), but generally, an one-time ultrasonic welding process is not adopted for a thick battery in this industry (with a thickness equal to or more than 38 mm).

The connecting assemblies and batteries according to Embodiments 1 to 14 are suitable for a case of too many layers for the positive and negative electrodes (equal to or more than 100 layers for both the positive and negative electrodes) and for a case of a large thickness (with a thickness equal to or more than 38 mm).

It should be understood by those skilled in the art that in the disclosure of the present invention, the orientation or positional relationship indicated by the terms “upper”, “lower”, “front”, “rear”, “left”, “right”, “vertical”, “horizontal”, “top”, “bottom”, “inner”, “inner” and the like is based on the orientation or positional relationship shown in the drawings, which is only for the convenience of describing the disclosure and simplifying the description, but does not indicate or imply that the referred device or element must have a specific orientation, be constructed and operated in a specific orientation, and thus the above terms cannot be understood as limiting the disclosure. Although the disclosure has been disclosed by the preferred embodiment in the above, it is not intended to limit the disclosure and any person familiar with the art can make some changes and embellishments without departing from the spirit and scope of the disclosure; therefore, the scope of protection of the disclosure should be subject to a scope of protection as claimed in the claims.

What is claimed is:

1. A battery core connecting assembly, which is configured for connecting a core of a lithium-ion battery, wherein the lithium-ion battery comprises a top cover and the battery core connecting assembly comprises:
an adapting piece comprising a first tongue and a second tongue which are connected with each other, the first tongue being configured to be welded with the core, the adapting piece being pliable at a pliable part of the first tongue and the second tongue, and the adapting piece having a multi-layer structure at least at the pliable part; and
a connecting piece at least in part comprising a single-layer structure, the connecting piece being connected with the second tongue of the adapting piece, and the connecting piece being welded with the top cover at a position of the single-layer structure.

2. The battery core connecting assembly according to claim 1, wherein the first tongue and the second tongue are formed with a rounded corner at the pliable part, on a section of the adapting piece.

3. The battery core connecting assembly according to claim 2, wherein a diameter of the rounded corner ranges from 1.25 T to 2.5 T, wherein T is a total thickness of the adapting piece.

4. The battery core connecting assembly according to claim 1, wherein the adapting piece and the connecting piece are two independent components, the connecting piece having a single-layer structure and the adapting piece having a multi-layer structure.

5. The battery core connecting assembly according to claim 4, wherein the connecting piece comprises a connecting piece body and connecting arms extending from the connecting piece body, the second tongue being welded with the connecting arms and a number of the connecting arms corresponding to a number of adapting pieces.

6. The battery core connecting assembly according to claim 5, wherein the adapting piece is formed into an L-shape after the pliable part of the first tongue and the second tongue are bent, and there are two connecting arms and two adapting pieces, and the connecting arms are distributed on a same side or different sides of the connecting piece body.

7. The battery core connecting assembly according to claim 4, wherein a number of connecting pieces is equal to that of adapting pieces, and the connecting piece comprises an ultrasonic welding part for welding with the top cover and a welding part for welding with the adapting piece.

8. The battery core connecting assembly according to claim 7, wherein there are at least two connecting pieces, and ultrasonic welding parts of the two opposite connecting pieces are arranged oppositely so as to be welded with the top cover.

9. The battery core connecting assembly according to claim 1, wherein the adapting piece and the connecting piece are an integrally formed component.

10. The battery core connecting assembly according to claim 9, wherein both the connecting piece and the adapting piece are made of multi-layer materials, and the connecting piece is formed with a single-layer structure by molecular welding at a welding position with the top cover.

11. The battery core connecting assembly according to claim 1, wherein at least at the pliable part, a thickness of a single layer of the adapting piece ranges from 0.05 mm to 0.2 mm, a number of layers of the adapting piece ranges from 2 to 8, and a total thickness of the adapting piece ranges from 0.3 mm to 1.8 mm.

12. The battery core connecting assembly according to claim 11 is wherein the adapting piece comprises a positive adapting piece and a negative adapting piece, a thickness of a single layer of the positive adapting piece ranging from 0.1 mm to 0.2 mm, a number of layers of the positive adapting piece ranging from 4 to 8, and a total thickness of the positive adapting piece ranging from 0.4 mm to 1.8 mm; and a thickness of a single layer of the negative electrode adapting piece ranging from 0.05 mm to 0.2 mm, a number of layers of the negative electrode adapting piece ranging from 2 to 6, and a total thickness of the negative electrode adapting piece ranging from 0.3 mm to 1 mm.

13. A multi-core battery comprising paired cores and a top cover, further comprising the battery core connecting assembly according to claim 1, wherein the paired cores are welded by small butterfly welding through the adapting piece, and the cores subjected to the small butterfly welding are finally welded with the top cover using large butterfly welding through the connecting piece.
